(19) United States
(12) Patent Application Publication
(10) Pub. No.: US 2014/0192965 A1
(43) Pub. Date: Jul. 10, 2014

(54) Method for blocking illegal prerecord messages (robocalls)

(71) Applicant: John Almeida, Richmond, CA (US)

(72) Inventor: John Almeida, Richmond, CA (US)

(21) Appl. No.: 14/133,402

(22) Filed: Dec. 18, 2013

Related U.S. Application Data
(60) Provisional application No. 61/749,808, filed on Jan. 7, 2013.

(51) Int. Cl. H04M 3/436; H04M 1/65

(52) U.S. Cl. CPC H04M 3/436; H04M 1/65
USPC 379/70; 379/210.02

(57) ABSTRACT

A method uses telephone number lists and a telephone exchange server to enable the blocking of illegal robocalls (prerecorded messages) and to enable the legal ones to proceed free of impediment. The method includes steps of providing a server computer; receiving at the server computer a first telephone number of a first telephone monitored by a first recipient; receiving permission from the first recipient to permit sending a telephone call to the first telephone when the telephone call originates from a second telephone number; storing the first telephone number and the second telephone number; intercepting a call to the first telephone number; determining an originating telephone number for a device making the intercepted call; and comparing the originating telephone number to the telephone number list and if the originating telephone number is in the telephone number list, then the server computer enabling the call to ring at the first telephone.

### CROSS-REFERENCE TO RELATED APPLICATIONS

This application claims the benefit of U.S. Provisional Application No. 61/749,808, filed 18 Mar. 2010, which is hereby incorporated by reference herein.

### TECHNICAL FIELD

In the field of telephonic communications, a method for blocking illegal robocalls without blocking the legal ones required by government agencies.

### BACKGROUND ART

Robocalls initiated by illegal entities has proliferated in the past few years and the U.S. Government has tried to stop them with legislation but to no avail. A great deal of illegal robocalls still happens in a daily basis especially with new technology that enables thousands of calls to be generated automatically to thousands of unsuspected recipients. These illegal robocalls are annoying and disruptive happening any time of the day or night and without any concerns to any existent law that prohibits such robocalls.

Furthermore, some of these robocalls are of criminal nature and defrauding may unsuspected victims of their hard earned money. A great deal of these illegal robocalls originate from the internet and usually coming from overseas and making difficult and sometimes impossible to be tracked and stopped. If the robocall originates from a country other than US it becomes hard or even impossible to prosecute suspects in case they are caught.

To further exacerbate the problem, the US congress has passed laws permitting government agencies to make legal robocalls and law enforcement agencies needs to disguise the caller ID of their telephone in the work of an investigation. Based on the aforementioned situation, it is quite challenging to come up with a system that is intelligent enough to block illegal calls while allowing the legal ones to pass through the telephone system without any impediment, but this is what it is required, a system with enough intelligence to differentiate between legal and illegal telephone prerecorded message.

### SUMMARY OF INVENTION

It is the object of this invention to demonstrate a method for solving the problems of the prior art by using a one or more tables to block illegal robocalls by comparing the incoming call with a user's telephone list, a government telephone list and an optional rejected telephone list. After a preset amount of time (days, hours, minutes, seconds, etc) a telephone number at the rejected list may be deleted from it.

If the incoming call is not in the government's telephone list or in the user's telephone list then the telephone exchange server sending a signal (the signal may be an electronic signal or a code part of the telephone signal—part of the telephone number or part of the caller ID) to the receiving telephone unit (cellular telephone or landline telephone) and the receiving telephone unit saving the incoming call in a separate message system at the receiving telephone unit or at the receiving telephone's exchange server or any other server and without ringing the receiving telephone unit.

If the signal is a code it may be placed by any computer (server computer) part of the telephone system. The server computer after verifying the appropriate authorization tables it determine what action is to be taken, then the server computer may insert the instruction anywhere at the telephone information envelop. The signal may be in the form of an instruction like: “[ring]” and it may be part of the caller ID or the telephone number like: “555-555-5555[ring]” and the recipient telephone unit will ring, or it may be like “555-555-5555[donnot-ring]” and the recipient telephone unit will not ring. After receiving the information with the instruction, the recipient telephone unit processes the information and decides if the call should proceed as normal or if the call should be sent to the answering mechanism of the recipient telephone unit or any other recording mechanism that may be attached to the recipient telephone unit. As an optional step, the receiving telephone unit waiting a specified time delay (e.g. one minute) before making the received telephone call available to the user.

A robocall is a call where the calling unit transmits a prerecorded message for the telephone recipient unit and the prerecorded message (audio or other visual format) may be from a political party inviting voters to vote at the election day or may be a message selling goods or services to the recipient telephone user, some robocalls are legal while others are illegal and it is the goal of the invention presented herein to teach a method and apparatus that will block the illegal robocalls while the legal ones be allowed proceed to the intended recipient user.

Also, as an optional step, the telephone exchange server verifying if the calling telephone number is in the user's telephone list with a server accessible by the telephone exchange server and if it is then allowing the call to proceed normally. If it isn't, then the telephone exchange server checking with a government list that is accessible by the telephone exchange server and if the calling number is at the government list then the call proceeding as usual and the user's telephone unit ringing normally. If the calling number is not in either telephone list, the government or the user, the telephone exchange server sending a signal to the receiving telephone unit and the receiving telephone unit (if it is a landline) or the receiving telephone exchange server (if it is a cell phone) and the signal indicates that the incoming call is not in either list and might be illegal. The term telephone exchange server is to be broadly interpreted and to include any server associated with the telephone system or any computer used for the purposed of connecting a communication link between two users.

The receiving unit proceeds and saves the received call without ringing the telephone. The saved received message may be placed separate from other normal messages where the user of a receiving telephone doesn't answer the call and the call goes to a message saving system. Further, once the telephone exchange server cannot locate the calling telephone number in either telephone list (government or user) the telephone exchange server may contact a server that is responsible for keeping track of the unlisted telephone number and the server saves the calling number and the called number. The saving of the message may be done by any computer associated with the telephone system or by the recipient's telephone unit.

A present number of times that a telephone can call without the called number being in either of the two described telephone number list may be predefined, like up to three calls may be made from the same number or from the same caller ID number and the called numbers not in either list and if that happens, the calling number is automatically flagged for a person to check it and if it is confirmed to be an illegal robocall the person confirms that it is illegal and the server contacts other servers (telephone exchange server, telephone unit or any other server used for saving the incoming message) and sends a signal with the flagged telephone number and the receiving server proceeds to delete all the messages it has saved for the incoming illegal robocall number, thus the call may never be presented to the recipient user.

Once a prerecorded call is saved, a time threshold may be set and it will be a delay to be waited by the saving device before presenting the saved message to the recipient user. This time threshold will enable the receiving device to receive the message without ringing the telephone unit and to record it without the telephone recipient's knowledge of the same. After the time threshold expires then the recipient's telephone unit may notify the recipient user that a recorded message has been received and the recipient's unit may indicate a signal like a flashing LED (Light Emitting Diode) or a message that states that the recorded message is not of authorized nature as to warn the user that it may be a fraudulent message. The received message may be saved at a message system within the recipient's unit (telephone unit or a server) that is separate from the regular messages known to be approved messages thus avoiding confusion on the user's part, as well, all message can be saved on a single messaging system and an identification used to identify approved message apart from non-approved ones.

Preferably, the period of flagging an illegal robocall and notifying all computers or devices that have saved the incoming messages should be done within a preset time waiting threshold as previously described. If the set time threshold is one minute than the flagging by the person and the person's notification of the servers should also be accomplished within the one-minute time threshold (it can be longer or shorter). If the call was to a landline telephone, the telephone exchange server may send a signal to the receiving telephone unit (if the message was saved by the telephone unit) along with the illegal robocall number and the landline telephone unit proceeds and delete the saved message, as already stated, it is preferably that the complete process be done within the preset time threshold. If the complete process happens within the preset set time threshold then the received illegal robocall will be deleted and without the receiving user noticing it, thus avoiding any annoyance whatsoever.

Also, while an answering machine or a server computer (saving message device) is saving an message for an unauthorized the saving message device may give the caller an option to enter a password or to answer a puzzle that only a human can answer and if the entered password or the answered puzzle is correct the saving message device allowing the recipient telephone unit to ring as to notify the user of the incoming call. If it is a password then the password is known to the caller and stored in the saving message device. If it is a puzzle, like a message, enter “1209” and if the caller can enter the correct number sequence then the saving message unit will enable the recipient telephone number to ring. By implementing this mechanism in conjunction to the other mechanisms described herein in unauthorized caller may be able to reach the recipient user, this will save a problem when someone related to the recipient needs to contact the recipient user and is calling from a telephone not known to the recipient telephone unit nor known to the recipient user.

Further the authorized robocall user must be registered with the government server in terms to be able to login with the server and supply to the server a list of the telephone numbers that the authorized robocall user will be using in the process of performing the automated calls. The registration process will enable only authorized entities to use the authorized system to place automated messages.

As will be appreciated by one of skill in the art, the present invention may be embodied as a method or a computer program product. Accordingly, the present invention may take a form of an entirely software embodiments or an embodiments combining software and hardware. Furthermore, the present invention may take the form of a computer program product on a computer-readable storage medium having computer-readable program code means embodied in the medium. Any computer readable medium may be utilized including but not limited to: hard disks, CD-ROMs, optical storage devices, or magnetic devices.

### BRIEF DESCRIPTION OF DRAWINGS

The accompanying drawings, which are incorporated in the form a part of this specification, illustrate embodiments of the invention and, together with the description, serve to explain the principles of the invention:

FIG. 1 illustrates the method of preferred embodiment of the present invention where a server blocks unauthorized phone calls while letting the authorized ones through.

FIGS. 2-3 are a further embodiment of FIG. 1 and they illustrate telephone numbers being deleted from the government telephone list.

FIG. 4 is a further embodiment of FIG. 1 and it illustrates a list of blocked telephone numbers.

FIG. 5 is a further embodiment of FIG. 1 and it illustrates one or more servers arranged for managing the one or more database tables and managing the saving of messages for each recipient's telephone unit

FIGS. 6-7 illustrate the process flow of the preferred embodiment of the present invention.

FIG. 8 illustrates telephone numbers saved as hashed values corresponding to the actual telephone number, so as to protect telephone user's privacy.

FIG. 9 illustrates the parsing the messages (audio or visual) and creating a hashed value corresponding to the complete message or corresponding to parts of the messages.

FIG. 10 illustrates an embodiment for saving the message for the receiving telephone unit.

FIG. 11 illustrates a further embodiment of FIG. 10 where the receiving telephone unit checking and/or fetching its messages.

FIG. 12 illustrates the server computer inserting instructions/commands in to the signal part of the telephone protocol information.

### DESCRIPTION OF EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

An embodiment of the present invention is a method for blocking illegal prerecorded messages, the method comprising the steps of: providing a server computer; the server computer comprising a non-transitory storage medium; a telephone number list of authorized telephone numbers of recipients telephone units stored in the non-transitory storage medium; the telephone number list comprising telephone numbers of recipients telephone units that will receive authorized prerecorded messages; receiving at the server computer a first telephone number and the server computer saving the first telephone number in the telephone number list; wherein the first telephone number is the actual first telephone number or a hashed value representing the actual first telephone number; receiving at the server computer a second telephone number of a first recipient telephone unit, wherein the second telephone number was transmitted to the server computer by a telephone central office; wherein the second telephone number is the actual second telephone or a hashed value representing the actual second telephone number; and the server computer matching the received second telephone number against the authorized telephone number list and if a match exists, the server computer returning a positive signal to the telephone central office as to enable the telephone central office to complete the call and forward the prerecorded message to the first recipient's telephone unit.

The embodiment may further comprise the steps of: a recipient user's telephone number list stored in the server computer non-transitory storage medium; wherein the recipient user's telephone number list is associated with the first recipient telephone unit; wherein the recipient user's telephone number list contains a telephone number associated with a second recipient telephone unit; receiving at the server computer a third telephone number of a second recipient telephone unit; wherein the third telephone number is the actual third telephone number or a hashed value representing the actual third telephone number; wherein the third telephone number was transmitted to the server computer by a telephone central office; and if the server computer cannot find a match between the received second telephone number and the authorized telephone numbers' list, the server computer checking for a match between the received third telephone number and the recipient user's telephone number list, if a match exists, the server computer returning a positive acknowledgement to the central office as to enable the central office to complete the call to the first recipient telephone unit.

The embodiment may further comprise the steps of: a recipient user's telephone number list stored in the server computer non-transitory storage medium; wherein the recipient user's telephone number list is associated with the first recipient telephone unit; wherein the recipient user's telephone number list contains a telephone number associated with a second recipient telephone unit; receiving at the server computer a third telephone number of a second recipient telephone unit; wherein the third telephone number is the actual third telephone number or a hashed value representing the actual third telephone number; wherein the third telephone number was transmitted to the server computer by a telephone central office; and if the server computer cannot find a match between the received second telephone number and the authorized telephone numbers' list, the server computer checking for a match between the received third telephone number and the recipient user's telephone number list, if a match doesn't exists, the server computer returning a negative acknowledgement to the central office as to enable the central office not to complete the call to the first recipient telephone unit.

The embodiment may further comprise the steps of: a rejected telephone list stored in the server computer non-transitory storage medium; a blocked telephone number list stored in the server computer non-transitory storage medium; the server computer saving the received third telephone number in the rejected telephone list; the server computer counting the number of times the third telephone number was saved in the rejected telephone list and if the rejected list contains the third telephone number a number of times that is greater or equal to a predefined number of times that a telephone number can be saved in the rejected list, the server computer saving a message received by received third telephone number; the server computer alerting a human user; the human user determining if the saved message is an illegal prerecorded message and if it is, the human user placing the third telephone number in the blocked telephone number list and the server computer saving the third telephone number in the blocked telephone number list; and the server computer deleting any saved message associated with the third telephone number.

The embodiment may further comprise the step of: the server computer deleting the first telephone number from the telephone number list.

An embodiment of the present invention is a method comprising the steps of: providing a server computer; the server computer comprising a non-transitory storage medium; a recipient user's telephone number list stored in the server computer non-transitory storage medium; the recipient user's telephone number list comprising a first telephone number of a first recipient telephone unit and a second telephone number of a second recipient telephone unit; wherein the first telephone number is the actual first telephone number of a hashed value of the actual first telephone number; wherein the second telephone number is the actual second telephone number of a hashed value of the actual second telephone number; receiving at the server computer a third telephone number from a telephone central office; wherein the third telephone number is the actual third telephone number or a hashed value representing the actual third telephone number; wherein the third telephone number was transmitted to the server computer by a telephone central office; and the server computer using the received third telephone number and looking for a match between the third telephone number and the second telephone number at the user's telephone number list, if a match exists, the server computer returning a positive acknowledgement to the telephone central office as to enable the central office to complete the call to the second recipient telephone unit.

The embodiment may further comprise the steps of: a telephone number list of authorized telephone numbers of recipients telephone units stored in the non-transitory storage medium; the telephone number list comprising telephone numbers of recipients telephone units that will receive authorized telephone call; receiving at the server computer a fourth telephone number and the server computer saving the fourth telephone number in the telephone number list of authorized telephone numbers of recipients telephone units; wherein the fourth telephone number is the actual fourth telephone number or a hashed value representing the actual fourth telephone number; if the server computer cannot find a match between the received third telephone number and the second telephone number at the user's telephone number list, the server computer checking for a match between the received third telephone number and fourth telephone number of the authorized telephone numbers of recipients telephone units, if a match exists, the server computer returning a positive acknowledgement to the central office as to enable the central office to complete the call to the second recipient telephone unit.

The embodiment may further comprise the steps of: a telephone number list of authorized telephone numbers of recipients telephone units stored in the non-transitory storage medium; the telephone number list comprising telephone numbers of recipients telephone units that will receive authorized telephone call; receiving at the server computer a fourth telephone number and the server computer saving the fourth telephone number in the telephone number list of authorized telephone numbers of recipients telephone units; wherein the fourth telephone number is the actual fourth telephone number or a hashed value representing the actual fourth telephone number; if the server computer cannot find a match between the received third telephone number and the second telephone number at the user's telephone number list, the server computer checking for a match between the received third telephone number and fourth telephone number of the authorized telephone numbers of recipients telephone units, if a match doesn't exists, the server computer returning a negative acknowledgement to the central office as to enable the central office to not to complete the call to the second recipient telephone unit.

The embodiment may further comprise the steps of: a rejected telephone list stored in the server computer non-transitory storage medium; a blocked telephone number list stored in the server computer non-transitory storage medium; the server computer saving the received third telephone number in the rejected telephone list; the server computer counting the number of times the third telephone number was saved in the rejected telephone list and if the rejected list contains the third telephone number a number of times that is greater or equal to a predefined number of times that a telephone number can be saved in the rejected list, the server computer saving a message received by the third telephone number; the server computer alerting a human user; the human user determining if the saved message is an illegal telephone call and if it is, the human user placing the third telephone number in the blocked telephone number list and the server computer saving the third telephone number in the blocked telephone number list; and the server computer deleting any saved message associated with the third telephone number.

The embodiment may further comprise the step of: the server computer deleting the fourth telephone number from the telephone number list.

An embodiment may comprise the steps of: providing a server computer; the server computer comprising a non-transitory storage medium; a first telephone number representing a first recipient's telephone unit stored in the non-transitory storage medium; a telephone number list of authorized telephone numbers of recipients telephone units stored in the non-transitory storage medium; the telephone number list comprising telephone numbers of recipients telephone units that will receive authorized telephone call; receiving at the server computer a second telephone number and the server computer saving the second telephone number in the telephone number list; wherein the second telephone number is the actual second telephone number or a hashed value representing the actual second telephone number; receiving at the server computer a third telephone number representing a second recipient telephone unit and a caller identification from the first recipient's telephone unit; and the server computer comparing the first telephone number and the caller identification and if the first telephone number and the caller identification are not the same, then the server computer comparing the received second telephone number and the third telephone number at the authorized telephone number list and if a match exists, the server computer enabling a communication connection between the first recipient telephone unit and the second recipient telephone unit.

The embodiment may further comprise the steps of: if the server computer can't find a match between the received second telephone number and the third telephone number at the authorized telephone number list, the server computer saving a message transmitted from the first recipient telephone unit to the second recipient telephone unit; and wherein the message is saved in the behalf of the second recipient's telephone unit.

An embodiment may comprise the steps of: providing a server computer; the server computer comprising a non-transitory storage medium; a first telephone number representing a first recipient's telephone number stored in the non-transitory storage medium; receiving at the server computer a third telephone number representing a second recipient telephone unit and a caller identification telephone number; the server computer comparing the first telephone number and the caller identification and if the first telephone number and the caller identification are not the same, then the server computer saving a message transmitted from the first recipient's telephone unit to the second recipient's telephone unit; and wherein the message is saved in the behalf of the second recipient's telephone unit and available for access by a user at the second recipient's telephone unit.

The embodiment may further comprises: parsing the message and deriving one or more hashed value; saving the hashed value in the non-transitory storage medium; the server computer checking the stored hashed value for match with other stored hash value and if there is a match the server computer notifying a human to check messages related to the matched hashed value; the human determining if the stored messages are an illegal prerecorded messages; if the human determines that the message is an illegal prerecord message, the human initiating a command for the server computer to delete all illegal prerecorded messages; the server computer storing first telephone number in blocked telephone list in a non-transitory storage medium; and the server computer blocking any future telephone calls originating from first telephone.

An embodiment for blocking illegal telephone call may comprise the steps of: providing a server computer; the server computer comprising a non-transitory storage medium; a blocked telephone list comprising at least one blocked telephone numbers stored in the non-transitory storage medium; a first telephone number representing a first recipient's telephone number stored in the non-transitory storage medium, wherein the first recipient's telephone number is associated with a first recipient's telephone unit; receiving at the server computer a third telephone number representing a second recipient telephone unit; the server computer comparing the first telephone number and the at least one telephone number stored in the blocked telephone list; and if the server computer locates the first telephone number in the blocked telephone list, the server computer ending the call without connecting the first recipient's telephone unit to the second recipient's telephone unit.

An embodiment may comprise a telephone unit for receiving a telephone call and saving an audio message without ringing the telephone unit, comprising: a telephone unit; the telephone unit comprising a non-transitory storage medium and a means for ringing the telephone set as to notify a user that a telephone call is being received; the telephone unit receiving a signal and the signal instructing the telephone unit not to ring the telephone unit; and the telephone unit saving an incoming message at the non-transitory storage medium.

The embodiment may further comprise: the telephone unit setting up a time delay before notifying a user of the stored message.

An embodiment of the present invention may include a server for receiving a telephone call and saving an audio message without ringing the recipient's telephone unit, comprising: a server; the server comprising a non-transitory storage medium; the server receiving an audio message and a telephone number; wherein the telephone number is the actual telephone number or a hashed value representing the actual telephone number; the server receiving a signal and the signal instructing the server to set a waiting time delay; the server associating the audio message with the telephone number and saving the audio message and the telephone number at the non-transitory storage medium; the server waiting time delay; and after the waiting time delay has expired, the server calling a telephone unit associated with the telephone number and after the telephone unit answering the call the server transmitting the audio message to the telephone unit.

The embodiment of the present invention may include a server for receiving a telephone call and saving an audio message without ringing the recipient's telephone unit, comprising: a server; the server comprising a non-transitory storage medium; the server receiving a first audio message and a first telephone number; wherein the first telephone number is the actual first telephone number or a hashed value representing the actual first telephone number; the server associating the first audio message with the first telephone number and saving the first audio message and the first telephone number at the non-transitory storage medium; the server computer hashing the first audio message producing a first hashed value and saving the first hashed value at the non-transitory storage medium; the server receiving a second audio message and a second telephone number; wherein the second telephone number is the actual second telephone number or a hashed value representing the actual second telephone number; the server computer hashing the second audio message producing a second hashed value and saving the second hashed value at the non-transitory storage medium; and the server computer associating the second hashed value with the first audio message.

An embodiment of the present invention may include a server for saving hashed value representing a telephone number, comprising: a server; the server comprising a non-transitory storage medium; the server receiving a first telephone number; the server hashing the first telephone number producing a first hashed value and the server saving the first hashed value at the non-transitory storage medium; the server receiving a second telephone number; the server hashing the second telephone number and producing a second hashed value; the server fetching the first hashed value; and the server comparing the first hashed value with the second hashed value and if the first hashed value is the same as the second hashed value, the server computer producing a signal indicating that the first hashed value and the second hashed value are the same.

An embodiment of the present invention may include a server for saving hashed value representing a telephone number, comprising: a server; the server comprising a non-transitory storage medium; the server receiving a first telephone number; the server hashing the first telephone number producing a first hashed value and the server saving the first hashed value at the non-transitory storage medium; the server receiving a second hashed value; the server fetching the first hashed value; and the server comparing the first hashed value with the second hashed value and if the first hashed value is the same as the second hashed value, the server computer producing a signal indicating that the first hashed value and the second hashed value are the same.

An embodiment—Authorized Calls—Before an authorized agency sends a robocall may include steps that first synchronize the telephone numbers it will be calling with an authorized telephone numbers list; after each call, deleting the just called telephone number from the authorized telephone numbers list; each telephone recipient having his/her contact telephone numbers in a users authorized list; if the calling telephone number is in the authorized telephone numbers list or in the user telephone numbers list then the recipient telephone unit will ring. Unauthorized Calls—If the calling telephone number is not in the authorized telephone numbers list and not in the global users authorized telephone numbers list, or, if the calling telephone number and the caller ID are not the same, checking the recipient telephone number against the authorized telephone numbers list and if it is not there, sending a signal to the recipient telephone unit as to enable the recipient telephone unit to accept the call without ringing the telephone unit; saving the calling telephone number in a reject telephone numbers list; if the saved telephone number has reached a predetermined number of times that the same number can be on the reject telephone numbers list within a predetermined time frame (for instance, 3 unauthorized call within 3 minutes), save a call and notify a human user; if the human user determines that the call is an illegal robocall, then placing the telephone number in a blocked telephone numbers list; after the telephone number is included in the blocked list, contacting all the telephone units or servers that have saved the illegal robocall and sending a signal to delete the saved message related to the blocked telephone number and without ringing the telephone unit; and, if a telephone number is in the blocked telephone numbers list then any future call from the telephone number must be blocked.

An embodiment—Authorized Calls—Before an authorized agency sends a robocall steps may include first synchronizing the telephone numbers it will be calling with an authorized telephone numbers list; after each call, deleting the just called telephone number from the authorized telephone numbers list; each recipient telephone unit having a contact telephone numbers stored in the telephone unit; if the calling telephone number is in the authorized telephone numbers list or in the recipient telephone unit telephone numbers contact list then the recipient telephone unit will ring. Unauthorized Calls—If the calling telephone number is not in authorized telephone numbers list, or, if the calling telephone number and the caller ID are not the same, checking the recipient telephone number against the authorized telephone numbers list and if it is not there, sending a signal to the recipient telephone unit as to enable the recipient telephone unit to accept the call. If the calling telephone number is in the recipient's telephone unit's contact telephone list the recipient telephone unit will ring, otherwise it will not ring; saving the calling telephone number in a reject telephone numbers list; if the saved telephone number has reached a predetermined number of times that the same number can be on the reject telephone numbers list within a predetermined time frame (for instance, 3 unauthorized call within 3 minutes), save a call and notify a human user; if the human user determines that the call is an illegal robocall, then placing the telephone number in a blocked telephone numbers list; after the a telephone number is included in the blocked list, contacting all the telephone units or server that have saved the illegal robocall and sending a signal to delete the saved message related to the blocked telephone number and without ringing the telephone unit; and, if a telephone number is in the blocked telephone numbers list then any future call from the telephone number must be blocked.

An embodiment—Authorized Calls—Before an authorized agency sends a robocall may implement steps of first synchronizing the telephone numbers it will be calling with an authorized telephone numbers list; after each call, deleting the just called telephone number from the authorized telephone numbers list; each telephone recipient having his/her contact telephone numbers in a users authorized list; if the calling telephone number is in the authorized telephone numbers list or the user telephone numbers list then the recipient telephone unit will ring. Unauthorized Calls—If the calling telephone number is not in the authorized telephone numbers list and not in the global users authorized telephone numbers list, or, if the calling telephone number and the caller ID are not the same, checking the recipient telephone number against the authorized telephone numbers list and if it is not there, a server computer saving the message and waiting a preset waiting time frame; saving the calling telephone number in a reject telephone numbers list; after the waiting time frame has elapsed and if the saved message is not from an illegal robocall, the server contacting the telephone unit and transmitting the saved message; if the saved telephone number has reached a predetermined number of times that the same number can be on the reject telephone numbers list within a predetermined time frame (for instance, 3 unauthorized call within 3 minutes), save a call and notify a human user; if the human user determines that the call is an illegal robocall, then placing the telephone number in a blocked telephone numbers list; if a telephone number is in the blocked telephone numbers list then any future call from the telephone number must be blocked; and, After the telephone number is included in the blocked list, contacting all the telephone units or servers that have saved the illegal robocall and sending a signal to delete the saved message related to the blocked telephone number and without ringing the telephone unit.

An embodiment—Authorized Calls—Before an authorized agency sends a robocall, it may implement steps of first synchronizing the telephone numbers it will be calling with an authorized telephone numbers list; after each call, deleting the just called telephone number from the authorized telephone numbers list; each telephone recipient having his/her contact telephone numbers in a users authorized list; if the calling telephone number is in the authorized telephone numbers list or the user telephone numbers list then the recipient telephone unit will ring. Unauthorized Calls—If the calling telephone number is not in the authorized telephone numbers list and not in the global users authorized telephone numbers list, or, if the calling telephone number and the caller ID are not the same, checking the recipient telephone number against the authorized telephone numbers list and if it is not there, the recipient telephone unit saving the message without ringing and waiting a preset waiting time frame; after the waiting time frame has elapsed and if the saved message is not from an illegal robocall, the server contacting the recipient telephone unit presenting the saved message to the recipient user; saving the calling telephone number in a reject telephone numbers list; if the saved telephone number has reached a predetermined number of times that the same number can be on the reject telephone numbers list within a predetermined time frame (for instance, 3 unauthorized call within 3 minutes); place the telephone number in a blocked telephone numbers list; and, if a telephone number is in the blocked telephone numbers list then any future call from the telephone number must be blocked.

An embodiment of the present invention includes a method for transmitting of an instruction to a recipient telephone unit, the method comprising the steps of: providing a server; the server computer is connected to a recipient telephone unit; the server computer transmitting a signal and the signal comprising an instruction part of the recipient telephone signal; and, the instruction instructs the recipient telephone unit to perform an action, wherein the action comprises one or more of: receiving a telephone call without ringing the recipient telephone unit; deleting a message stored at the recipient telephone unit; and, performing any function that is native to the telephone unit.

The embodiment may further comprise: a telephone number; and, a location information.

An embodiment of the present invention may involve the transmitting of an instruction to a recipient telephone unit, the method comprising the steps of: a telephone unit; the telephone unit is connect to server computer; the telephone unit receiving a signal from a server computer and the signal comprising an instruction part of the telephone signal; and, the instruction instructs the recipient telephone unit to perform an action, wherein the action comprises one or more of: receiving a telephone call without ringing the recipient telephone unit; deleting a message stored at the recipient telephone unit; and, performing any function that is native to the telephone unit.

The embodiment may further comprise: a telephone number; and a location information.

A preferred embodiment of this invention involves a method for blocking illegal robocalls and at the same time enabling the legal robocalls to be sent to the receiving telephone unit. By telephone unit it is to be understood any kind of telephone in use to day or to be invented in the future and it may be any mobile device or landline device. As well, any explanation for the landline device applies to a mobile device and vice-versa.

The method may involve at least one telephone list, the user's telephone list, and it is used for keeping the user's telephone numbers. It may involve a government telephone list for keeping the numbers used by the government to call recipient user's telephone unit. The government telephone list may comprise the calling telephone number and the recipient telephone number, but it may only comprise the recipient telephone number.

Also, an optional list of rejected telephone numbers used by a server to verify if rejected telephone numbers belongs to specific telephone number in the rejected list and if it does, the server computer flagging the telephone number and notifying a human for verification of the call. If it is determined by the human that the call is indeed an illegal robocall then the human user initiating a notification to the telephone exchange server or any servers that were used to save the illegal robocalls.

The server may proceed and delete all the saved illegal robocalls from its non-transitory storage unit. The term telephone exchange server is to be broadly interpreted to include Central Office (CO) which is responsible for the local telephone user's connection to the telephone system, as well it is to be interpreted any part of the telephone system used to record messages, route telephone calls or to connect one telephone user to another telephone user.

The method further involves a separated saving unit for saving incoming message by the receiving telephone unit or the telephone exchange server used to save the received supposed illegal robocall, this is a preferred method but not a requirement. Also, a preset time threshold may be used before a saved message is presented to the recipient user at the recipient telephone unit. If a preset time threshold is used, the recipient telephone unit may only present the saved call to the recipient user once the preset time threshold expires.

Also, if the saved message is an illegal robocall, the preset time threshold may be used to enable the recipient telephone unit to delete the saved message within the preset time threshold without presenting the message to the recipient user. Thus, once the deletion happens within the preset time threshold the illegal robocall will be hidden from the user of the receiving telephone unit.

Further, if the incoming call has been identified by the telephone exchange server (central office server or any server associated with the telephone system) to be an unauthorized call and once the telephone exchange server forwards the incoming call to the receiving telephone unit, the telephone exchange server will send a signal to the receiving telephone unit and the receiving unit will identify the signal as an instruction to save the received message at its storage medium (transitory or not) without ringing the telephone unit. The receiving telephone unit may save the received message at a separate messaging system (not a requirement) and set a time threshold for the message and the message will only be presented to the recipient user after the preset time threshold expires.

The method may be implemented with a step wherein the messages is saved by the telephone exchange server or any server associated with the telephone system used for the purpose of saving messages to the users. If the telephone exchange server saves the message, then the signal may not be sent to the receiving telephone unit and the time delay may not be setup since the whole process happens within the telephone system.

After the telephone system server (exchange server or central office server) has determined that the received robocalls are actually illegal ones, the server computer may proceed with a process for deleting them from one or more servers where they were saved. The telephone's system server will send a signal to each server with the saved message and the signal will contain the message's identification, the receiving server will use the received signal as instructions for the receiving server to delete the illegal robocall using the message's identification.

Next, the telephone system server preferably proceeds to include the robocall telephone number in a blocking list. After the telephone number is included in the blocked list, the telephone system server will block any further call using the illegal robocall telephone number. The process of blocking any further illegal robocall preferably happens at the time the telephone system server receives the call, it will check the received telephone number with the server hosting the list with the blocked telephone numbers, if the received telephone number is included in the list with blocked telephone numbers then the telephone system server will simply block the incoming call without saving its message and without ringing the recipient's telephone unit.

The saving of received audio messages for the unlisted telephone numbers that are passed to the recipient telephone unit may be performed by the telephone unit itself or may be performed by a separate server, this is actually done by mobile cellular telephone companies and the same method may be implemented for landlines units as well. The managing of the audio messages and the managing of database tables with telephone lists may be performed by a single server or may be performed by a plurality of servers in a network or on the Internet.

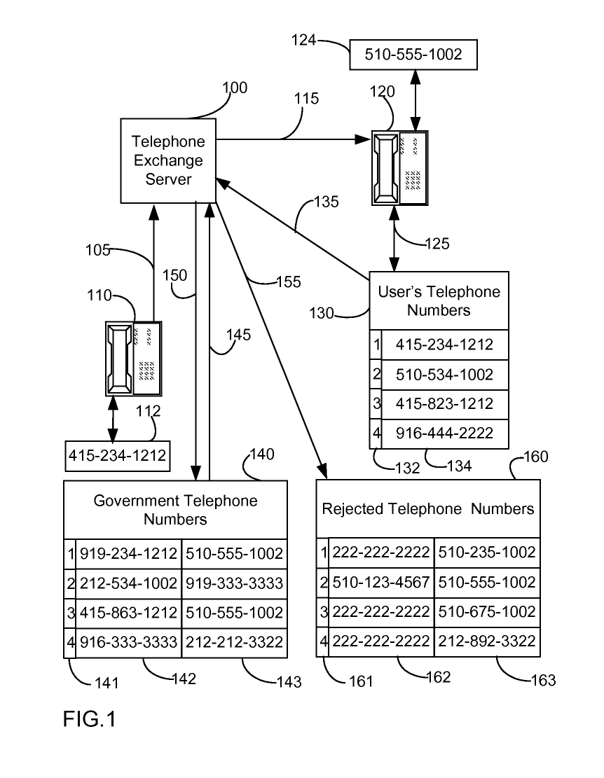

Let's proceed and described the embodiment of the present invention. FIG. 1 illustrates the preferred embodiment of the present invention and it illustrates a telephone exchange server (100) and it is the go-in-between the calling telephone unit (110) and the recipient telephone unit (120). By a telephone unit is to be broadly interpreted and the telephone unit may be an actual unit like a cellular telephone unit, a mobile telephone unit, landline telephone unit, a computer that acts as the telephone unit when initiating a call or receiving a call, as well it can be any type of telephone unit already know or to invented later. The telephone exchange server (100) may be any kind of server used by the telephone system including the central office server.

Once a calling telephone unit (110) initiates a call (105) by entering a telephone number (124) of the receiving telephone unit (120), the call goes to a telephone exchange server owned by a telephone operator (100). Next, the telephone exchange server (100) will verify where the receiving telephone unit (120) is located then select the proper communication channel (115) and access the receiving telephone unit (120) based on the receiving telephone unit's telephone number (124).

It is the goal of the preferred embodiment of the present invention to block all illegal robocall but to allow legal robocall or authorized calls to go through. There are instances that as required by local laws government agencies are permitted to send robocall to telephone recipients. As we proceed and explain the embodiment of the present invention it will be clear that legal robocall will be allowed to go through but illegal ones will be blocked or eliminated.

The embodiment of the present invention may include a user's telephone numbers list (130) that may be saved on a server computer accessed (125) by the telephone unit (120), or the user list may reside on the telephone unit itself, and the user list may be updated every time the user of telephone unit (120) adds, change or delete a telephone number at the telephone unit (120) and if it is connected to a server computer the server computer automatically updates the user's telephone numbers list (130) based on the user's changes, deletions or additions. The user's telephone numbers list (130) comprises two columns: a row number (132) and a telephone list (134) of telephone numbers associated with the recipient user of telephone unit (120) and the telephone numbers (134) are used by the user of telephone unit (120) to send and receive telephone calls.

A government telephone numbers list (140) is used by government agencies for saving robocall numbers that a government or authorized agency will using to call one or more telephone numbers. The government telephone numbers list (140) comprises three columns: first column with row numbers (141); a second column with a list of government's authorized telephone numbers (142) and a third column with a list of the recipient telephone numbers (143) that the government or authorized agency will call. By government telephone numbers (140) is to be broadly interpreted and include government and private entities, in case a private entity using the system, it will register with the server controlling the authorized robocall telephone list, but for the purpose of the explanation of this invention the term government entity, government agency or simply agency will be used.

After the telephone unit (110) places a telephone call (105), the telephone exchange server (100) will identify the calling telephone number (112) associated with the telephone unit (110) and the telephone exchange server (100) proceeds and accesses (135) the user's telephone numbers (130). The server will verify if the user's telephone numbers (130) contains the calling telephone numbers (112) in the user's telephone list (130) column (134) and in this particular exemplary example it does (row #1 (132) has ‘415-234-1212’ (134) and it is the same calling number (112)), next, the telephone exchange server (100) will connect the calling telephone unit (110) to the called telephone unit (120) thus completing the call and the recipient telephone unit (120) rings.

The user's telephone list (130) may be a contact list containing telephone numbers used in most smart telephones. The list (130) may be stored (125) at the recipient telephone unit (120), it may be stored at any server that the user's telephone unit (120) accesses, it may be stored at the telephone exchange server (100) or any other server part of the telephone system.

### EXAMPLE 1

This example is of a method for selectively allowing ringing of a telephone. The method includes steps of providing a server computer, the server computer comprising a non-transitory storage medium; receiving at the server computer a first telephone number of a first telephone monitored by a first recipient; receiving permission from the first recipient to permit sending a telephone call to the first telephone when the telephone call originates from a second telephone number; storing in the non-transitory storage medium a telephone number list comprising a first representation of the first telephone number and a second representation of the second telephone number; and intercepting a call to the first telephone number, the intercepting performed by the server computer, the call comprising an intercepted call; determining an originating telephone number for the device making the intercepted call; and comparing the originating telephone number to the telephone number list and if the originating telephone number is in the telephone number list, then the server computer enabling the call to ring at the first telephone. In this example, the first representation may be the complete and unaltered telephone number, or a hashed value of the complete and unaltered telephone number. Similarly, the second representation may be a complete and unaltered telephone number, and a hashed value of the complete and unaltered telephone number.

Let's assume a scenario where the calling telephone number is not in the user's telephone number list. Let's say that the calling telephone unit (110) telephone number (112) is “555-123-4567” and in this scenario the number “555-123-4567” is not in the user's telephone numbers list (130). If this happens, that is, the telephone exchange server (100) cannot find the calling number (112) in the user's telephone number list (130), the telephone exchange server (100) proceeds and fetches the government telephone numbers (140) and if the recipient telephone number (124) is present in the list and in this case it is (row #1 (141)) the first telephone number (143) of the first row of the government telephone numbers list (140). Again the telephone exchange server (100) will proceed and connect (115) to the recipient's telephone unit (120) and the telephone unit (120) rings. Row #1 (141) contains the calling telephone number (142) and the called telephone number (143). The calling telephone number (142) “555-123-4567” is the assumed telephone number and not the actual telephone number (112). The government table (140) may only comprise the recipient telephone numbers row (143) and without the calling telephone number (142).

In case the telephone number (112) of the calling unit (110) is not in the user's telephone numbers (130) and the recipient's unit (120) telephone number (124) is not in the government telephone numbers (140) then it means that the calling number is unauthorized by the user's telephone unit (120) and also the calling number is unauthorized by the government's controlling entity (140). But it doesn't necessarily mean that the call is illegal, it may be a legitimate call from someone associated with the user of the receiving telephone unit (120) and the number is not yet at the user's telephone numbers list (130). In this situation, the telephone exchange server (100) will perform two steps. The first step involves saving (155) the calling telephone number (112) into a rejected telephone numbers list (160) and at the second step the telephone exchange server (100) will sent a signal (115) to the receiving telephone unit (120) and the receiving telephone unit (120) will identify the received signal and interpret it as meaning that the telephone unit (120) should not ring.

If the received call (115) is without any audible message, the receiving telephone unit (120) may proceed and delete the call without any further action. If the receive call has an audio signal then the receiving telephone unit (120) will proceed and save the call an set a time threshold, for instance one minute. The audio message may be saved by the receiving unit (120) or by a server associated with it, more of it later. The time threshold means that only after the time threshold expires the message will be presented to a user of the receiving telephone unit (120). The preset time threshold is optional and not a requirement for the functionalities of the present invention.

In case the calling telephone numbers (112) is saved at rejected telephone numbers list (160) from calling units (110) reach a specified predefined number threshold (the number of times a calling telephone number is allowed into the rejected list), let's say that a the predefined number of times is three, that is, the same telephone number may appear in the rejected list up to three times. For the purpose of our explanation, let's assume that the telephone number (112) for the calling telephone unit (110) is “222-2222-2222”. Proceeding, rows #1, #3 and #4 (161) has the same telephone number “222-2222-2222” (162) calling a plurality of recipient telephone numbers (163).

Since the calling telephone number “222-2222-2222” appears in the rejected telephone numbers list (160) then the server managing the rejected telephone numbers list (160) will proceed and save one of the incoming call audio messages and create an alert for a human intervention. After a human intervenes and listens to the saved audio message and if it is determined that the audio message is indeed an illegal robocall, the person dealing with the situation will actuate a process on the server and the server will send the rejected telephone number “222-222-2222” to all servers that saved an audio message containing the illegal robocall and each server will simply delete all messages associated with the telephone number “222-222-2222”.

The time period from the time the server managing the rejected telephone numbers (160) sets the alarm off to the time the responding user takes action to listen to the saved message and the time it takes to initiate a call for the deletion of the illegal robocall is preferably that it be within the time threshold set by the receiving unit (120), and if the two time thresholds are within the same range the user of the receiving unit (120) will never be notified that has received call nor about saved message. If the time threshold set by the server managing the rejected telephone numbers list (160) is greater than the time threshold that was set by the receiving unit (120) then the receiving unit (120) may display the message to the user and it may be in a way that the user may know that the received message may be from an authorized source.

### EXAMPLE 2

### Rejected Calls

This example builds on Example 1 above and includes method steps for dealing with rejected telephone calls. The steps of Example 1, above, further includes a step of the server computer saving the originating telephone number in a rejected telephone number list if the originating telephone number is not in the telephone number list. The added steps may also include any one or more of the following steps: rejecting any subsequent call from the originating telephone number; the server computer counting the number of times the originating telephone number; saving the originating telephone number in a rejected telephone list; if the rejected list contains the originating telephone number a number of times that is greater or equal to a predefined number of times that a telephone number can be saved in the rejected list, then the server computer saving a message received from the originating telephone number; the server computer alerting a user that the originating telephone number has connected the predefined number of times that it can be saved in the rejected list; the server computer receiving an audio message from the originating telephone; the server setting up a time delay for notification to the user that an audio message has been received; the server waiting for the expiration of the time delay; after the time delay has expired, the server calling the first telephone and transmitting the audio message to the telephone unit.

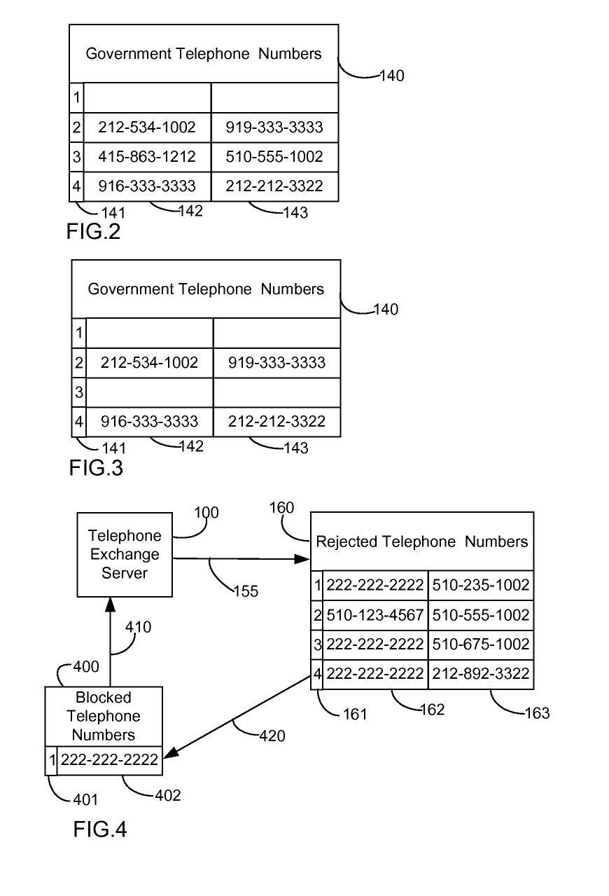

As the telephone exchange server (100) access (145) a valid telephone number from the government telephone number list (140) and the number is used to call (115) the recipient's telephone number (120) the telephone exchange server (100) access (150) the government telephone numbers list (140) and delete the number that was used to call the recipient telephone unit (120). If we look at the first row of the government telephone numbers list (140) it illustrates at row #1 (141) the government number “919-234-1212” (142) and the recipient number “510-555-1002” (143) and it is the same recipient telephone number (124). If we now look at FIG. 2, it illustrates the same government telephone numbers list (140) from FIG. 1 and row #1 (FIG. 1 (141)) is blank, that is the number has been deleted from the list and it cannot be used any longer to perform a second call. The same explanation applies to FIG. 3 and it illustrates row #3 has been deleted and at row #3 (FIG. 1 (141)) it illustrates the same recipient number “510-555-1002” (FIG. 1 (143)) and the government number “415-863-1212” (FIG. 1 (142)) and it means that the government number “415-863-1212” (FIG. 1 (142)) called the recipient number “510-555-1002” (FIG. 1 (143)) and after the call was performed the telephone exchange server (100) accessed (150) the government telephone numbers list (140) and delete the number pair from the table and it is reflected on FIG. 3 where row #3 column (141), column (142) and column (143) are blank indicating that the database record was deleted.

As for this exemplary illustration, telephone exchange server (100) is deleting (150) a record from the government telephone numbers list (140) after the authorized entity has performed the call to a recipient. But the government telephone numbers list (140) may be managed by a server other than the telephone exchange server (100) and the telephone exchange server (100) will send a signal (150) to the server responsible to manage the government telephone numbers (140) and the server will proceed and delete the record, the same applies for reading data from the server managing the government telephone numbers (140), the telephone exchange server (100) will send a requesting signal (145) to the server managing the government telephone numbers list (140) and the server will return the requested record to the telephone exchange server (100).

Continuing with FIG. 1. Let's proceed and explain the purpose of the user's telephone numbers list (130) and the government telephone numbers list (140). Starting with the user's telephone numbers (130). The reason the user's telephone numbers list (130) is available for access by the telephone exchange server (100) is simply because it contains the recipient's authorized telephone numbers used by the recipient to call and to receive calls from others telephone users. Since this list is managed by the recipient then the recipient can add or delete a telephone number at any time by using the telephone device like a smart telephone, or by going to Internet and setting up an account with an authorized server to manage the list for all users, or the server storing the list (130) reading the list from a cloud where the user's list is stored.

Next, the government telephone numbers list (140) is used by an authorized entity to call a recipient. Before the authorized agency performs the call a computer, the authorized agency performing the call(s) contact the server managing the government telephone numbers list (140) and transmit the list of the number that will take part of the call, the pair of the authorized entity number (142) and the recipient's number (143). This way the telephone exchange server (100) will know that the number being called is from an authorized source. The reason that a record is deleted from the database after an authorized entity performs the call is simply to protect an un-authorized entity from reusing the authorized number-pair and performing a second call. As illustrated by FIGS. 1-3, a first authorized entity made a first call and the first row was deleted (FIG. 2 (140)) then a second authorized entity made a second call and the third row (FIG. 3 (140)) was deleted. The government telephone numbers list (140) may only contain the recipient's telephone number (143) without the agency's telephone number (142).

As it was stated, after an un-authorized telephone number calls, the telephone exchange server (100) will pass the call (115) to the recipient telephone (120) along with a signal that the recipient telephone (120) uses to accept the call without ringing the receiving device and the receiving device performs two steps: 1) reproduces a prerecorded message from the recipient user stating the user is unavailable and after the message is played, the receiving telephone device records the message; 2) the receiving telephone set sets a waiting time threshold before letting the recipient user know that a message has been recorded. If the recorded message has no audio then the device may delete it before the preset time threshold expires, the reason for deleting empty message is because many robocalls don't leave a message once a voice message system is in place. If the message is a legitimate message, for instance, a message from someone needing to contact the recipient and the caller's number is not yet in the recipient's telephone number's list, then after the preset time threshold expires the recipient's telephone device will notify that a new message has been received.

The user's telephone numbers list (130) may be managed by any server and made available to the telephone exchange server (100) for access and for the recipients telephone device (120) as well. Now the access from the telephone device (120) may be done by the device itself, by a computer managing the device's telephone number list (130) or by the user owner of the telephone device (120) managing the user's telephone list (130) at the server using the Internet or any other means.

Continuing with FIG. 1's teachings. Let's now further explain the rejected telephone numbers list (160). The calling device's telephone number (112) is connected to the telephone exchange server (100) and after the calling telephone (110) initiates a call (105) to the called telephone number (120) and a user at the calling device (110) enters the called telephone device's (120) number (124) then the telephone exchange server (100) uses the recipients telephone number (124) to connect (115) with the recipients telephone device (120). As we've already explained, if the recipient's telephone number (124) is stored in a government telephone numbers (140) the call will be passed (115) to recipient's telephone device (120) and the telephone device (120) will ring. If the calling number (112) is at the user's telephone numbers (130) the same will happen, that is, the telephone exchange server (100) will connect (115) with the recipient's telephone device (120) and the telephone device (120) will ring. These two processes apply to authorized callers but there are other unauthorized callers as well and we'll deal with them next. There may be a predefine time frame that once passed the telephone numbers stored in the rejected telephone numbers (160) may be delete from the database.

Let's once again assume that the number (112) of the calling telephone device (110) is “510-123-4567” and not “415-234-1212”. If we look at the user's telephone numbers (130) the number is not in the user's telephone numbers list (130) column (134) and the first check done by the telephone exchange server (100) fails, next, the telephone exchange server (100) performs a second check at the government telephone numbers (140) and again the telephone number “510-123-4567” is not in the government telephones list (140) column (142) and the second check fails as well. After the two checks have failed the number is placed in the rejected telephone numbers (160) first column row #2 (161) and second column (162) and the called telephone number is placed at the third column (163). The telephone exchange server (100) still proceeds (115) with the call to the receiving telephone device (120) and the telephone exchange server (100) sends a signal to the receiving telephone device (120) and the receiving telephone device (120) uses the received signal as an indication that the incoming call is not an authorized call and the receiving telephone device (120) will produce the regular user's messages stating that no one is available and to leave a message and once the message is received from the telephone device (110) the receiving telephone device (120) will save it and set a waiting time threshold as already described in detail, except this last time the receiving telephone device (120) will not ring, thus not disturbing the user.

FIG. 4 illustrates the rejected telephone numbers list (160) and it is the same one of FIG. 1. The second row #2 first column (161) there is the unauthorized number “510-123-4567” at the second column (162) the number “510-555-1002”, at the third column (163) the number “510-555-1002” and it is the same number (FIG. 1 (124)) of the receiving device (FIG. 1 (120)) and it may be an associate to the recipient of the receiving device (FIG. 1 (120)). The first column (161) row #1 and rows #3-4 have at the second column (162) the unauthorized number “222-222-2222”. The computer managing the rejected telephone numbers (160) will set an alarm once a number of received unauthorized messages are receive and based on a preset number threshold and in this case of this exemplary explanation is three unauthorized messages, row #1 and rows #2-3.

After the alarm is set the computer managing the rejected telephone numbers (160) proceeds and save the received audio message and a human may intervene and check the saved audio message and if the audio message is an illegal robocall then the human user may instruct the computer that it is an illegal robocall and the computer will communicate with all of the computers that have saved the illegal robocall so each one may delete it and/or the computer may simply save the illegal robocall number is a blocked telephone numbers (400) first column (401) and second column (402), next, the telephone exchange server (FIG. 1(100)) will use it and block any new incoming calls for the blocked number (402) and no one else will receive future calls and for those who have already received a call, the audio message will be deleted and it is preferred that the complete process happens within the preset waiting time threshold set by the receiving telephone units (120), thus the message is deleted without the knowledge of the recipient user.

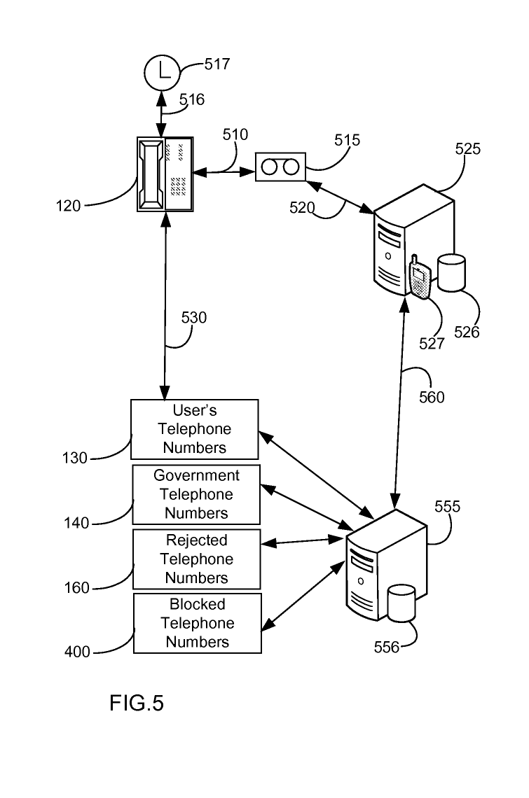

FIG. 5 is a further illustration of what has been discussed so far and it illustrates the storing of the telephone lists and the storing of audio messages by more than one server but it is to understood that the telephone numbers lists and the saving of the audio messages may be performed at a single computer as far the one or more servers is accessible by the telephone exchange server, it may as well be that all the saving be done by the telephone exchange server, central office, any server part of the telephone network or any server accessible to the telephone network.

FIG. 5 illustrates a server computer (555) with its database (556) and the server computer accesses the database (556) and saves to or reads from the user's telephone numbers (FIG. 1 (130)), the government telephone numbers (FIG. 1 (140)), the rejected telephone numbers (FIG. 1 (160)) or the blocked telephone numbers (FIG. 4 (400)). Server (555) may communicate (560) with a server (525) responsible for saving the audio messages (515). Server (525) may be used for storing received audio messages (515) in its database (526) or audio messages from mobile telephones like cellular telephones (527).

The audio message (515) may be associated (520) with server (525) or it may be associated (510) with the telephone unit (FIG. 1 (120)), that is, the audio message (515) may be stored at the telephone unit (FIG. 1 (120)), by the server (525), by server (555), or it may be saved at one or more combination comprising any number of saving devices or servers others than the arrangement depicted herein and it may include server (525), server (555) and device (FIG. 1 (120)). As well the message may be save at one device or at more than one device (server and telephone unit). The telephone unit (FIG. 1 (120)) may set (516) a time waiting threshold (517) before presenting (510) the message (515) to the telephone unit (FIG. 1 (120)) for a user's viewing.

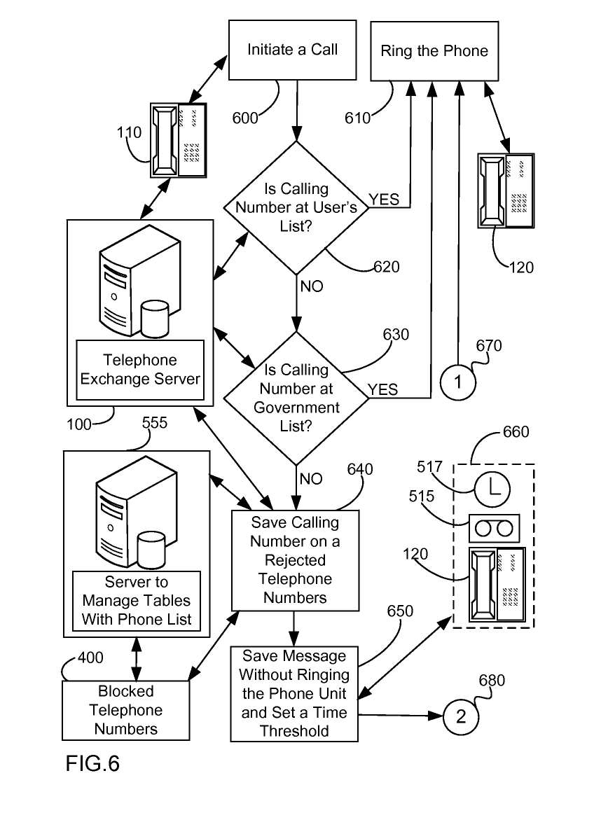

FIG. 6 illustrates a flowchart with the process flow of the present invention and it starts once the telephone user initiates a call (600) and it is associated with telephone unit (FIG. 1 (110)) and telephone exchange server (FIG. 1 (100)). Once the telephone user places a call (600), the telephone exchange server (FIG. 1 (100)) checks to see if the called number is in the recipient user's list (620), table (FIG. 1 (130)).

If the called telephone number is in the recipient telephone list (FIG. 1 (130)) the telephone rings (610), telephone unit (FIG. 1 (120)). If the calling telephone number (the number of the telephone unit initiating the call) is not in the recipient's telephone list (620) then the process flows and the telephone exchange server (FIG. 1 (100)) checks to see if the called number is in the government list (630), table (FIG. 1 (140)), if it is, then the telephone rings (610), telephone unit (FIG. 1 (120)).

If the calling is not in the government list (630) then the telephone exchange server (FIG. 1 (100)) will save the calling number in the rejected telephone number list (640), table (FIG. 1 (160)). Then the calling number from the rejected telephone number list (640) will be available to telephone exchange server (FIG. 1 (100)) or any other server responsible for managing the list (FIG. 5 (555)). The server (FIG. 5 (555)) or the telephone unit (FIG. 1 (120)) proceeds and save the message without ringing the telephone unit (650), if the message is saved by the receiving telephone unit system (660), then the receiving telephone unit (660) will set a time delay (FIG. 5 (517)) and record the message (FIG. 5 (515)) and the message will be available to the recipient telephone unit (FIG. 1 (120)).

There will be a predefined number of times that a telephone number can be stored in the rejected list (640), for instance: three times. Once a third call from the same calling telephone number is rejected and saved on the rejected telephone list (640) on the server (FIG. 5 (555)), the server (FIG. 5 (555)) will automatically flag the call for a user intervention and listening, more of it will be explained later. After the calls have been determined by the user to be illegal robocalls, then the calling number (robocall) will be placed in a blocked telephone list (FIG. 4 (400)) and saved by the server (FIG. 5 (555)).

As already explained, after it is determined that the calling number is a robocall, server (FIG. 5 (555)) will proceed and contact any server or any recipient telephone unit and send a signal and the calling telephone number indicating that the saved call associate with the calling telephone is an illegal robocall and the unit, server or telephone, having the saved call will proceed and delete it and if it is done within the time delay (517) set by the telephone system (660) the recipient user will not notice that an illegal robocall was received. If the exchange server saved (FIG. 1 (100)) the call, then the complete process happens in the server (FIG. 1 (100)) without contacting any recipient's telephone unit. The telephone system (660) is a new embodiment of the present invention where the telephone unit comprises the waiting time delay (FIG. 5 (517)), the recording unit (FIG. 5 (515)) and the telephone set (FIG. 1 (120)).

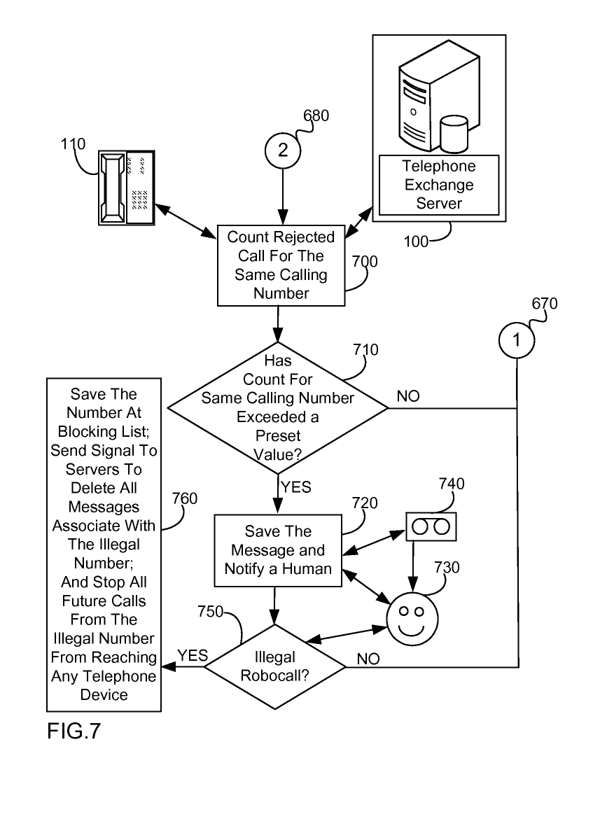

FIG. 7 illustrates a further explanation of FIG. 6 involving the process to determine if the saved telephone numbers is indeed an illegal robocall. After the message has been saved (FIG. 6 (650)) the process flows (FIG. 6 (680)) to FIG. 7 proceeding to count the number of rejected calls for the calling telephone number (700) and if an allowed number of times that a telephone number can be saved in the rejected list (700) has been reached (710) then the message will be saved (720) and human notified (730), if the counter still bellow the allowed number of times that a telephone number can be saved in the rejected telephone list, the process goes back to the beginning (600).

After the human (730) has determined that the call is indeed an illegal robocall (740) then the human user (730) will proceed and notify of such and the server (FIG. 5 (555)) will proceed and execute the following steps: save the number at blocking list; send Signal to servers to delete all messages associate with the illegal number; and stop all future calls from the illegal number from reaching any telephone device (750) ending the process and destroying any saved illegal robocall and stopping any future ones from propagating to telephone recipients.

The embodiment may as well be implemented where a preset waiting time frame is used along the preset number of times the same telephone number can be in the rejected list. For instance, if the preset number of times that the same telephone umber may be present in the rejected telephone numbers list is three and the preset waiting time frame is three minutes, if the same telephone number makes three unauthorized calls within a three minutes time frame the third call will trigger the saving of the incoming call and a warning for a human user intervention.

Central Office Overview

Before proceeding, let's review the telephone central office part of the telephone system. Each telephone line is connected to a central office. The central office in the US is identified by the first three digits of the telephone number, for instance, if the telephone number is: 515-323-4312, the ‘515’ represents the area code, the first three digits ‘323’ represents the central office where the telephone ‘4312’ is hardwired thereto. So, the central office is represented by ‘323’ and the user telephone number ‘4312’, but to make things easier for a human to understand the actual telephone number that the user will give out will be 323-4312 and if the user is giving the number to a caller outside of the user's area code than the user gives out the telephone number, the central office number and the area code and it is: 515-323-4312; 515 (the area code); 323 (the central office); and 4312 (the user telephone number).

Once a call is placed by the user to another number at the save central office like: ‘323-4312’ calling ‘323-4455’; two thinks will happen when the calling user picks up the telephone the central office #323 where the user's telephone number ‘4312’ is connected to will notice that the telephone is off the hook and will issue a dial tone. The calling user will call ‘323-4455’ and the central office #323 will simply connects the user of the telephone number ‘4312’ to the user of the telephone number ‘4455’ because they both are located in the same central office #323 and the telephone ‘4455’ will ring.

The calling number ‘4312’ will send two information to the called telephone number ‘4455’, it will send the complete calling number ‘323-4312’ as a caller identifier (caller ID) and the number called ‘323-4455’ to the central office #323 and the central office #323 will pass the caller ID (other information may be passed as well like where the telephone is located—area code) to the called number ‘4455’ and if the recipient's device has a display for displaying the caller ID it will display ‘323-4312’ and the complete cycle finishes.

The caller ID can be manipulated by the calling telephone unit or by a computer associated with the calling telephone unit or by many other means and the caller ID can be changed to any number chosen by the calling user and the user's chosen number will be the number that will be displayed by the receiving telephone unit, or the caller ID may simply be suppressed and may not be displayed at all by the receiving telephone unit. The term caller ID is to be broadly interpreted to include instance where a caller ID is suppressed and not sent or any value that is sent in the place of the caller ID.

If the calling telephone user enters an area code as part of the called telephone number, let's say that the calling user ‘323-4312’ calls ‘555-678-1234’ then the central office #323 located at the area code ‘515’ will pass the call to the area code ‘555’ and it will be redirected to the central office #678 located at the area code ‘555’ and the same process already explained for calls within the same central office applies here as well.

Now the embodiment of the present invention. Once a calling user suppresses the caller ID so it may not appear on the receiving telephone unit or if the caller ID is changed by the calling user to a number other than the actual calling telephone number then the central office will check the recipient user's telephones list and the government authorized telephone list and if the number is not in either list then the caller ID number will be listed in the rejected telephone list and the message be saved for future presentation to the recipient and the recipient may be notified that the message has a changed caller ID. The embodiment may be implemented where only the government telephone number list is checked without checking the user's telephone numbers list. The complete process was already explained like if a preset number of the same calling disguised number is saved in the rejected list then a human may be notified and the human will check it and so on.

One final observation of the embodiments of the present invention. Since privacy is always of a great concern and since users' telephone numbers are stored in a database that may be accessed by an entity other than the actual user, it is advised to have each telephone number hashed by an algorithm (a program to change numeric values into another value by using a mathematical formula) that produces a hash value of the actual number and store the hash value instead, and once the server storing the tables with the hash values receives an actual number the server simply converts the actual number to a hash value using the same algorithm that was used to produce the stored value then search the database based on the stored hash value therefore not infringing any one's privacy. The word hash value is to be broadly interpreted to include a telephone number if the hash value includes a telephone number as well a telephone number is to be broadly interpreted as to include a hash value of the telephone number.

Another use of the hashing technique may be for checking stored messages for recipient users, once a message is saved by the telephone exchange server or any server associate with the telephone system and the server used for the purpose of saving the message, the server then hashes the message's content and save in a special table and the table may be searched by the server to identify repeated messages saved on the table and after a predefined number of the same message is reached, the server notifying a human to verify if the message is a robocall and if it is proceeding to place the number in the blocked table as it has been already explained.

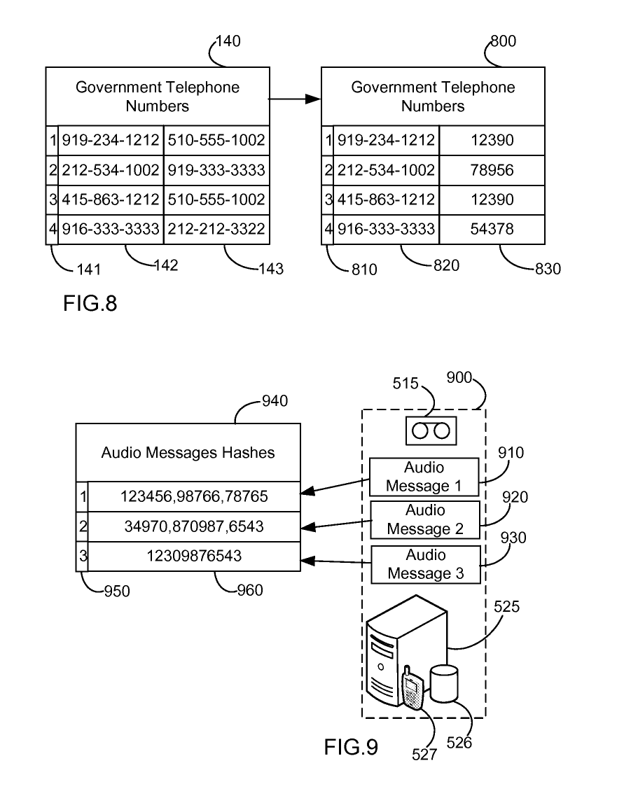

FIG. 8 illustrates the same government telephone numbers table (140) of FIG. 1 and its columns (141), (142) and (143). Column (143) is of special interest since it contains the user's numbers stored therein. Instead of or in addition to the table (140) it may be done by using hashing techniques to encode the users numbers and it is illustrated by a new government telephone numbers table (800) and it contain a row column (810), a calling telephone numbers column (820) and a hashed value for hashed telephone numbers (830). The hashed telephone numbers column (830) is of special interest and the telephone ‘510-555-1002’ (143) row #1 and row #3 (141) are represented by hashed value ‘12390’ (830) and the same explanation applies to row #2 and row #4. So, instead of keeping the actual user's telephone number, a hashed value to represent the telephone number is saved.

Only the government table was illustrates in this exemplary explanation but any table using the actual user's telephone number may be hashed and the hashed value be saved in the place of the actual value and once the server needs to locate a telephone number the server hashes the actual telephone number deriving a hash value then using the hashed value to search the table based on hash values. The server may receive the actual hashed value representing the actual telephone number and this case, the server simply uses the hashed telephone number and search the table based on the stored hashed value.

FIG. 9 illustrates the messaging system (900) used for saving audio messages for recipient users, if the audio message is store in a server associated with the telephone system then the server may hashes the complete audio message and saves it into the database, or the server may break the audio message, hashing each individual piece of it and saving a series of hashed value in a database in a searchable format. If the saved hashed values relate to a message (single message to a plurality of recipients) then only a single message may be saved on the server computer and the hashed values representing the saved message be used in a database to identify the messages and play it to users as needed without having the same message saved to all users and by saving a single message and using the hashed values as a means for identifying and indexing the message.

The hashing technique will save storage space once used to a plurality of repeated messages but saving only a single message for all users and using the hashed values as means for identifying the single stored message. The saved message may be further compressed thus saving even more storage space on the computer non-transitory storage medium. This is important if the message is a legal prerecorded message (robocall) and sent to many users and if some of the users may choose to have their messages saved in the central office or any other server, then space will be saved at the saving server.

Continuing with FIG. 9. The audio system (900) comprises the audio messaging (FIG. 5 (515)) and the server (FIG. 5 (525)), telephone system (FIG. 5 (527)) and the database (FIG. 5 (526)). The telephone system (FIG. 5 (527)) may be any user telephone unit associate with the system like a cellular telephone repeater tower, a mobile device, a telephone link to the server, etc. There are three audio messages; ‘Audio Message 1’ (910) and its hash values represented by column (960) of table ‘Audio Messages Hashes’ (940) and column (950) representing rows of the table (940) and row #1 column (960) containing the hashed values for ‘Audio Message 1’ (910). If we observe row #1 (950) column (960) the value is: ‘123456,98766,78765’ and the ‘,’ means that the message was broken into three sections and hashed the same explanation applies to ‘Audio Message 2’ (920) which is broken into three sections as well ‘34970,870987,6543’ row #2 (950) column (960). As for ‘Audio Message 3’ (930) the complete message was hashed and stored into row #3 (950) and hashed values column (960) as ‘12309876543’.

As stated before, after the telephone exchange server has received a call to a recipient telephone unit and the calling number is an unauthorized telephone number a preset waiting time may be set and the incoming message is saved and it can be saved by the recipient telephone unit or by any server associated with the telephone system. The preset waiting time is an option and not a requirement but is preferred that one be used. Once the messages has been saved for the recipient unit, and if was saved on a server computer part of the telephone system then the server computer will set the waiting time threshold and after the waiting time threshold expires the server computer may contacts the telephone exchange server passing the recipient telephone number and the telephone exchange server proceeds and calls the recipient telephone unit and once the recipient telephone unit answers the telephone exchange server fetches the message from the server computer and passes it on the recipient telephone unit and if a user answers the call the user will listen to the call, if a user doesn't answer the call the recipient telephone unit may save the incoming message in its storage medium, if it has one. The message may state that it was received from an unauthorized calling number so as to warn the recipient user. If a user doesn't answer the call and the recipient telephone unit doesn't have a recording medium then the process will repeat from time to time or will stay in the server computer for a predefined number of days and after that it may be deleted.

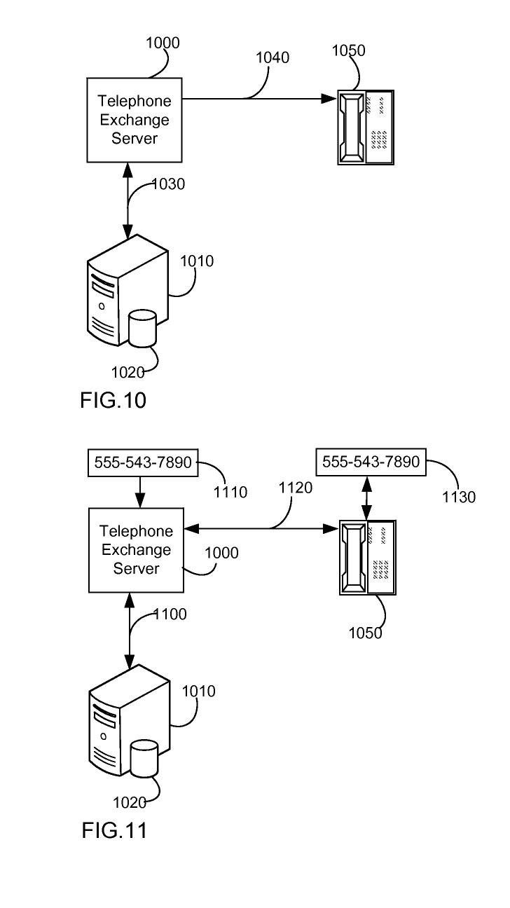

FIG. 10 illustrates the just described embodiment wherein the telephone exchange server (1000) once confirms that the received call is an unauthorized call, the telephone exchange server (1000) proceeds and saves the message (1030) at the server's (1010) non-transitory storage medium (1020). The telephone exchange server (1000) may set a predefined waiting time and if one is set and after it expires, the telephone exchange server (1000) contacts (1040) the telephone unit (1050) and after it answers the call, the telephone exchange server (1000) proceeds and contacts (1030) the server (1010) passing the telephone number associated with the telephone unit (1050) and the server (1010) using the received telephone number and fetching the saved message associated with the received telephone number from the non-transitory storage medium (1020) and playing it to the connected telephone unit (1050) through the telephone exchange server (1000) using connections (1040) and (1030). The term telephone exchange server may include any server associated with the telephone network system and there may be a single server or a plurality of servers doing all the operation or a central office server.

FIG. 11 illustrates a further embodiment of FIG. 10 wherein the user of the recipient telephone unit (1050) types the telephone number (1130) and it is the telephone number of the recipient unit (1050). Once the user enters the telephone number (1130) of telephone unit (1050) the telephone unit (1050) connects (1120) with the telephone exchange server (1000) and the telephone exchange server (1000) matches the received telephone number (1130) with the same telephone number (1110) that is saved on the telephone exchange server (1000) and once the match is accomplished, the telephone exchange server (1000) proceeds and accesses (1100) the server (1010) and a message may be played to the user at the telephone unit (1050) and the message may allow the user to change settings on the server (1010) by pressing certain key on the telephone unit (1050) or it may allow the user to check (1100) messages stored in the server (1010) non-transitory medium (1020) and pass (1100) the messages to the telephone exchange server (1000), then the telephone exchange server (1000) passing the message back to the telephone unit (1050) through connections (1100) and (1120), thus finalizing the process. It is important to notice that the user must enter the telephone number of the user's telephone unit from the telephone unit in terms for the process to be initialized. Again, the complete process may happen in a single server or in a plurality of servers.

The Signal Overview

Regarding the signal that may be sent to the recipient telephone unit, it may be in the form of an actual modulated signal, it can be part of the caller ID or it can be part of other information sent with the caller ID. For instance, if the caller ID is “555-345-6789” then it may be codified as “555-345-6789[DONTRING]” and the receiving telephone unit will simply use the “[DONTRING]” part of the caller ID as instruction not to ring the telephone set and present “555-345-6789” on the display, the same explanation applies to other part of the caller ID like the city where the calling is originating may also be used to have the instruction “[DONTRING]” part of it.

The signal may be further enhanced to include other instructions how the call should be handled, if the call is to be saved or deleted like: “555-345-6789[DONTRING-SAVE]” or “555-345-6789[DONTRING-DELETE]”. The first one, the telephone will not right and the incoming call will be saved and the second one the telephone will not ring and the previous received and saved message from “555-345-6789” will be deleted.

The global user's telephone list may be saved in the server or it may be saved on the telephone unit itself. If saved in the telephone unit it may be done each time the recipient user receives a call and the call is saved without ringing the telephone unit, the user may choose from the telephone unit to accept future calls from the telephone number associated with the saved message and the telephone number becoming an authorized telephone number. Once a new call comes from the previously authorized telephone number, the receiving telephone unit simply ignores the signal “[DONTRING]” and rings the telephone unit. The same mechanism may be implement at the time the user is making a call, the user may choose to accept calls from the telephone number the user is dialing, or it may be that the user chooses to receive calls from all the telephone numbers the user makes a call to using the telephone unit, or the user may create a telephone list at the telephone unit like a contact list in a smart phone. The list will be stored in the recipient telephone unit or in a group of telephone units used by the recipient user (cellular phone and a landline) and with a minimal intervention on the part of the user.

If the list is stored in a server computer then the user may access a website and type each telephone number in the authorized list, or the telephone set may simply automatically transfers and updates it's associated telephone number list stored at the server computer without the user's intervention.

The recipient telephone unit may have more than one messaging mechanism, for instance, it may have one messaging for authorized calls that are recorded once the user is not present to answer the incoming call and another that will state that the stored audio message was received from an unauthorized telephone number. This is not a requirement, the telephone unit may have a single messaging system, but it would be preferred that two distinct ones be available. Instead of having two distinct messages the telephone unit may simply have a LED (Light Emitting Diode) or a message or a flag or a beep to alert the user that the saved message is from an unauthorized telephone number.

The telephone unit may be equipped to perform a verification of a received and stored audio message from an unauthorized telephone number for audio, if there is no audio then the telephone unit may simply deletes the message without the user's knowledge thus preventing the user from calling back the unauthorized telephone number.

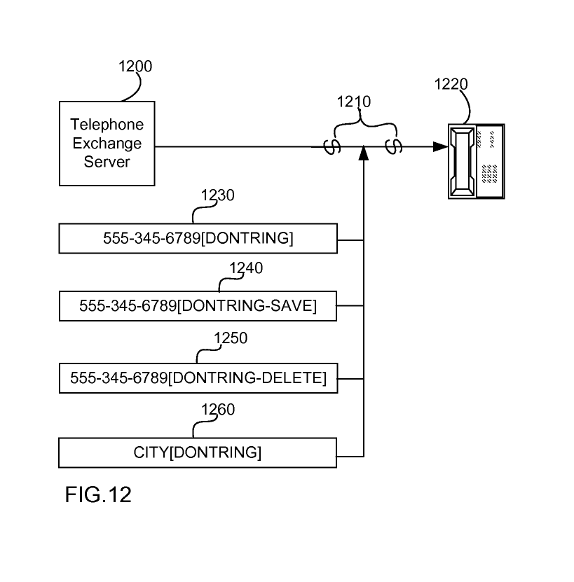

FIG. 12 illustrates the process of sending a signal (1210) from the Telephone Exchange Server (1200) to the recipient telephone unit (1220). The signal (1210) may contain the calling telephone number “555-345-6789” and an instruction “[DONTRING]” (1230). The recipient telephone unit (1220) uses the instruction part of the signal's information (1230) as an instruction to let the recipient telephone unit (1220) know what to do with the received call. The signal (1210) may instruct the recipient telephone unit (1220) not to ring (1230), or not to ring and save the received call as an audio message (1240), or to delete a previously received and saved audio message associated with the received telephone number (1250). Other part of the signal may be used as well, like the location where the call originates (1260) and it has the city and the instruction or any part of the received signal with an instruction may be used. The instruction may instruct the recipient telephone unit (1220) to perform any type of function part of the functionality of the unit (1220), not just the ones described herein.

Overview

Authorized Robocalls—A database table will be manages for all legal robocall and just before sending one or more robocalls to recipients the system responsible for sending the robocall will contact an associate server and place the just to be made robocalls in the authorized list, the list will contain the calling number and the calling number may be masked to a different number than the actual calling number and the recipient number. The recipient number may be hashed as not to reveal the actual number thus preserving the user's privacy. After each legal robocall is made the system will delete the called recipient number from the authorized list as not to enable any other party to make a second call. After a call is received by the telephone exchange server or the central office the server will verify if the telephone number pair is stored in the server and if it is, the telephone exchange server or the central office will complete the call to the recipient. The authorized robocalls list may be a single list for all authorized entities, but it can be more than one list as well.

Authorized Users' telephone List—Each user having the user's telephone number list stored in a server and the list comprising at least the recipient user's telephone number and associate with the telephone numbers that the recipient uses to call other users part of the recipient user's list. One or both numbers, the recipients number and the numbers used by the recipient to call others may be hashed value saved in the place of the actual number to protect user's privacy. After a call is placed by a calling user, the caller ID will be used to match a number stored in the user's list stored in the server computer and if there is a match the telephone exchange server or the central office proceeds and places the call to the recipient. The user's telephone list may be a single list stored in a database table for all users in the telephone system, but it can be more than one list as well.

Unauthorized Calls or Disguised Caller ID—When a calling user fakes the caller ID the central office server will deal with it. Once the central office server receives the caller ID, the server (central office or any other server) will match it against the calling user's actual telephone number and if it both numbers (the actual number and the caller ID) don't produce a match the central office server contacts a server responsible for matching the caller ID against the government authorized list (all the steps involved may be done by the central office server or by any other server) and if there is a match the call will be passed to the recipient user and the recipient's telephone will ring. If the caller ID and/or the actual telephone number is/are not in the authorized list, the recipient's telephone will not ring and a message will be saved for the recipient user and the number will be placed in a rejected list.

Finalizing. The authorized robocalls are placed on a onetime use database and no impediment on the call. The authorized users' telephone list will enable a call that the caller ID and the calling telephone number matches and the calling telephone number in the recipient's telephone number list to place the call without any impediment. Unauthorized calls or disguised caller ID will only be able to place the call without any impediment if at least the recipient's telephone number is in the authorized telephone number list for authorized robocalls.

If the calling party doesn't meet any of the above requirements then the recipient's telephone will not ring and the call will be forward to a message system controlled by recipient's telephone device or by the telephone system, the message will be presented to the recipient after a waiting preset time threshold has elapsed. Further, the at least the calling telephone number will be placed in a rejected telephone list and once the same number appears a preset number of times in the rejected telephone number list a human user will be alerted and the human user determines if the recorded message is an illegal robocall and if it is, the human user will place the calling number in a blocked list and any future call from the number will be permanently blocked. After the human user's determination that the call is indeed an illegal robocall the system proceeds and delete all saved calls from the blocked number without the recipient ever knowing of the received illegal robocall.

It may as well be that once the same telephone number is saved at the rejected list a certain number of times in a certain waiting period of time the user warning be activated. For instance, if the preset number of times that the same telephone number can appear in the rejected list is three times within a waiting period of three minutes then once the same telephone number is saved in the rejected telephone numbers list three times and within three minutes, the alarm will be set to warn the human user. If a waiting time delay has been set then it is preferred that the complete process from the saving of the illegal robocall to its deleting be performed before the waiting time delay expires.

It may also be implemented in a way that once the number of allowed times a telephone number may be present in the rejected list is reached and within a preset waiting time frame any further call from the same number will automatically be blocked without a user intervention.

### EXAMPLE 3

### The Telephone Unit

This example discusses the telephone unit upon which the methods disclosed herein may be implemented. The telephone unit is one capable of receiving a telephone call and saving an audio message without ringing the recipient's telephone unit. The telephone unit includes a central processing unit capable of being programmed to implement coded instructions; a non-transitory storage medium; and a signal generator to notify a user that a telephone call is being received. The central processing unit of the telephone unit is programmed with instructions stored on the non-transitory storage medium. The instructions when implemented cause the telephone unit: to respond to an instruction received at the telephone unit not to activate the signal generator; and to save an incoming message in the non-transitory storage medium. The telephone unit may also include instructions to activate a time delay before notifying a user of the incoming message that was saved.

### EXAMPLE 3

### A Method for Interacting with the Telephone Unit

This example illustrates a method of using a server computer and other components needed to interact with the telephone unit of Examples 1 and 2, above. In this example, the method is used for transmitting an instruction to a recipient telephone unit, and includes steps of providing a server computer; connecting the server computer to a recipient telephone unit, the telephone unit comprising a central processing unit capable of implementing coded instructions received by the recipient telephone unit; the server computer transmitting a coded instruction to the recipient telephone unit; and causing the central processing unit to implement the coded instruction causing an action, including any of the following: receiving a telephone call without ringing the recipient telephone unit; deleting a message stored at the recipient telephone unit; ringing a bell of the recipient telephone unit; turning on a light of the recipient telephone unit; and turning on a speaker of the recipient telephone unit.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the communications industry.

What is claimed is:

1. A method for selectively allowing ringing of a telephone, the method comprising the steps of:
providing a server computer, the server computer comprising a non-transitory storage medium;
receiving at the server computer a first telephone number of a first telephone monitored by a first recipient;
receiving permission from the first recipient to permit sending a telephone call to the first telephone when the telephone call originates from a second telephone number;
storing in the non-transitory storage medium a telephone number list comprising a first representation of the first telephone number and a second representation of the second telephone number; and
intercepting a call to the first telephone number, the intercepting performed by the server computer, the call comprising an intercepted call;
determining an originating telephone number for a device making the intercepted call; and
comparing the originating telephone number to the telephone number list and if the originating telephone number is in the telephone number list, then the server computer enabling the call to ring at the first telephone.

2. The method of claim 1, further comprising the step of the server computer saving the originating telephone number in a rejected telephone number list if the originating telephone number is not in the telephone number list.

3. The method of claim 2, further comprising the step of rejecting any subsequent call from the originating telephone number.

4. The method of claim 2, further comprising the steps of:
the server computer counting the number of times the originating telephone number;
saving the originating telephone number in a rejected telephone list; and
if the rejected list contains the originating telephone number a number of times that is greater or equal to a predefined number of times that a telephone number can be saved in the rejected list, then the server computer saving a message received from the originating telephone number.

5. The method of claim 4, further comprising the step of the server computer alerting a user that the originating telephone number has connected the predefined number of times that it can be saved in the rejected list.

6. The method of claim 1, further comprising the steps of:
the server computer receiving an audio message from the originating telephone;
the server setting up a time delay for notification to the first recipient that an audio message has been received;
the server waiting for expiration of the time delay; and
after the time delay has expired, the server calling the first telephone and transmitting the audio message to the first telephone.

7. The method of claim 1, wherein the first representation is selected from the group consisting of a complete and unaltered telephone number, and a hashed value of the complete and unaltered telephone number.

8. The method of claim 1, wherein the second representation is selected from the group consisting of a complete and unaltered telephone number, and a hashed value of the complete and unaltered telephone number.

9. A telephone unit for receiving a telephone call and saving an audio message without ringing the telephone unit, comprising:
a telephone unit;
the telephone unit comprising: a central processing unit capable of being programmed to implement coded instructions; a non-transitory storage medium; and a signal generator to notify a user that a telephone call is being received; and
the central processing unit programmed with instructions stored on the non-transitory storage medium, the instructions when implemented cause the telephone unit:
to respond to an instruction received at the telephone unit not to activate the signal generator; and
to save an incoming message in the non-transitory storage medium.

10. The telephone unit of claim 9, further comprising instructions when implemented cause the telephone unit to activate a time delay before notifying a user of the incoming message that was saved.

11. A method for transmitting an instruction to a recipient telephone unit, the method comprising the steps of:
providing a server computer;
connecting the server computer to a recipient telephone unit, the telephone unit comprising a central processing unit capable of implementing coded instructions received by the recipient telephone unit;
the server computer transmitting a coded instruction to the recipient telephone unit; and
causing the central processing unit to implement the coded instruction causing an action selected from the group consisting of:
receiving a telephone call without ringing the recipient telephone unit;
deleting a message stored at the recipient telephone unit;
ringing a bell of the recipient telephone unit;
turning on a light of the recipient telephone unit; and
turning on a speaker of the recipient telephone unit.
